(19) United States
(12) Patent Application Publication
(10) Pub. No.: US 2026/0328552 A1
(43) Pub. Date: Oct. 22, 2026

(54) VECTOR MEASURING SYSTEMS AND METHODS

(71) Applicant: Right Hand Ruler LLC, Acworth, GA (US)

(72) Inventor: Paul Joseph Strapp, Acworth, GA (US)

(21) Appl. No.: 19/651,190

(22) Filed: Apr. 17, 2026

Related U.S. Application Data
(60) Provisional application No. 63/790,379, filed on Apr. 17, 2025.

(51) Int. Cl. G01B 5/252

(52) U.S. Cl. CPC G01B 5/252

(57) ABSTRACT

A vector measuring device can include a base, connecting pieces, and moveable parts. The base can connect to a pivot assembly, which can include a pivot mount, a pivot portion, and an arrow mount. The pivot mount can rotate with respect along a first axis, and the arrow mount can rotate with respect to the pivot portion along a second axis that is generally perpendicular to the first axis. Three directional indicators, such as arrows, can be attached to the arrow mount. Two of the directional indicators can be aligned with the corresponding directions of two input vectors, and the third directional indicator can identify the direction of a resultant vector when the two input vectors are multiplied.

### CROSS-REFERENCE TO RELATED APPLICATIONS

This application claims the benefit of, and priority to, U.S. Provisional Patent Application No. 63/790,379, filed on Apr. 17, 2025, and entitled “Vector Measuring Systems and Methods,” the entirety of which is incorporated by reference as if fully set forth herein.

### TECHNICAL FIELD

The present systems and processes relate to measuring devices for vectors.

### BACKGROUND

Vector measuring devices can be used to determine the direction of a resulting vector when two vectors are multiplied together. Traditionally, vector measuring is done by manipulating one's own hands to determine a resulting vector direction. Manipulating one's hands to determine a vector direction can be a cumbersome and sometimes challenging exercise. Additionally, such a hand-based measuring system can be difficult or impossible for those with disabilities or potential impediments.

Therefore, there is a long-felt but unresolved need for a device that can determine the direction of a resultant vector of two multiplied vectors.

### BRIEF SUMMARY OF THE DISCLOSURE

Briefly described, aspects of the present disclosure generally relate to a vector measuring device. The vector measuring device can include three arrows. The three arrows of the vector measuring device can determine the vector direction resulting from the product of two vectors. A first arrow of the vector measuring device can be aligned with the direction of a first input vector to be multiplied. A second arrow of the vector measuring device can be aligned with the direction of a second input vector to be multiplied. A third arrow of the vector measuring device can indicate the direction of a third, resultant vector.

The vector measuring device can be assembled by connecting various components together. For example, base-to-mount connectors can be attachable to a base and to a mount pivot. The mount pivot can have a generally cross-like shape, which can help enable the device to be manipulable in the direction of any given input vector. The mount support and the arrow mount can be attachable to the mount pivot (e.g., above the base-to-mount connectors). The mount support can be attachable to the arrow mount, and the arrows can be attachable to the arrow mount.

The disclosed technology includes a vector measuring device. The vector measuring device can comprise a base, a pivot assembly, and a plurality of directional indicators. The pivot assembly can have a first end and a second end. The pivot assembly can include a pivot mount, which can be located at the first end. The pivot mount can include (i) a base interface portion that is connected to the base and (ii) a first pivot interface portion. The pivot assembly can include an arrow mount, which can be located at the second end. The arrow mount can include a second pivot interface portion. The pivot assembly can include a pivot portion. The pivot portion can include (i) a first pivot rod connected to the first pivot interface portion of the pivot mount and (ii) a second pivot rod connected to the second pivot interface portion of the arrow mount. The plurality of directional indicators can be attached to the arrow mount and can include (i) a first directional indicator pointing in a first direction, (ii) a second directional indicator pointing in a second direction that is different from the first direction and (iii) a third directional indicator pointing in a third direction that is different from both the first direction and the second direction.

The base can have a generally oblong shape and can comprise a first base end and a second base end. The first base end can comprise a flared bottom portion. The second base end can comprise a recessed ring configured to interface with one or more protrusion of the pivot mount.

The pivot mount can be configured to rotate about a vertical axis of the base that intersects the base interface portion of the pivot mount.

The pivot mount can comprise (i) a first pivot mount portion comprising a first pivot recess configured to receive at least a portion of a first end of the first pivot rod and (ii) a second pivot mount portion comprising a second pivot recess configured to receive at least a portion of a second end of the first pivot rod. The first pivot mount portion can be attached to the second pivot mount portion to form the pivot mount. The pivot mount can be configured to rotate about a first rod axis that is approximately perpendicular to a vertical axis of the base that intersects the base interface portion of the pivot mount.

The pivot mount can be detachably attachable to the base and the pivot portion.

The first pivot rod can be affixed to the second pivot rod. The first pivot rod can be approximately perpendicular to the second pivot rod.

One or more interfacing surfaces of the pivot portion, one or more interfacing surfaces of the pivot mount, and/or one or more interfacing surfaces of the arrow mount can comprise ridges to thereby cause rotation between (i) the first pivot rod and the pivot mount or (ii) the second pivot rod and the arrow mount to define a plurality of predefined angular positions therebetween.

The arrow mount can comprise (i) a first arrow mount portion comprising a first pivot recess configured to receive at least a portion of a first end of the second pivot rod and (ii) a second arrow mount portion comprising a second pivot recess configured to receive at least a portion of a second end of the second pivot rod. The first arrow mount portion can be attached to the second arrow mount portion to form the arrow mount. The arrow mount can be configured to rotate about a second rod axis that is approximately perpendicular to a vertical axis of the base that intersects the base interface portion of the pivot mount. The first arrow mount portion and/or the second arrow mount portion can comprise three arrow connectors. Each arrow connector can be configured to attach to a corresponding one of the plurality of directional indicators.

At least one of the arrow connectors and/or at least one of the plurality of directional indicators can comprise one or more detent protrusions, and at least one of the plurality of directional indicators and/or at least one of the arrow connectors can comprise one or more detent recesses.

The arrow mount can be detachably attachable to the pivot portion.

Each of the plurality of directional indicators can be detachably attachable to the arrow mount.

The first direction of the first directional indicator can correspond to a first axis of a Cartesian coordinate system, the second direction of the second directional indicator can correspond to a second axis of a Cartesian coordinate system, and the third direction of the third directional indicator can correspond to a third axis of a Cartesian coordinate system.

The pivot mount can be configured to rotate relative to the base. The pivot portion can be configured to rotate relative to the pivot mount along a first arc path. The arrow mount can be configured to rotate relative to the pivot portion along a second arc path that is different from the first arc path.

The pivot mount can be configured to rotate relative to the base about a central vertical axis of the base, wherein the central vertical axis intersects the base interface portion of the pivot mount. The pivot portion can be configured to rotate relative to the pivot mount about a first central rod axis extending through the first pivot rod. The arrow mount can be configured to rotate relative to the pivot portion about a second central rod axis extending through the second pivot rod.

The first central rod axis can be approximately perpendicular to the central vertical axis, and the second central rod axis can be approximately perpendicular to the first central rod axis.

One, some, or all of the base, the pivot assembly, the pivot mount, the pivot portion, the arrow mount, and the plurality of directional indicators can comprise a rigid material.

The method includes a method of using a vector measuring device. The method can comprise manipulating a pivot mount of a vector measuring device, a pivot portion of the vector measuring device, and/or an arrow mount of a vector measuring device. Such manipulation(s) can comprise rotating the pivot mount with respect to a base of the vector measuring device, rotating the pivot portion with respect to the pivot mount, and/or rotating the arrow mount with respect to the pivot portion. Such manipulation(s) can cause (i) a first directional indicator of the vector measuring device to align with a first direction of a first vector and (ii) a second directional indicator of the vector measuring device to align with a second direction of a second vector. The method can include determining a resultant direction of a third directional indicator of the vector measuring device, wherein the resultant direction corresponds to a third direction of a third vector resulting from a product of the first vector and the second vector.

The disclosed technology includes a method manufacturing a vector measuring device. The method can comprise attaching a pivot mount to a base. The method can comprise attaching a first pivot rod of a pivot portion to the pivot mount. The pivot portion can comprise the first pivot rod and a second pivot rod that is (i) fixedly attached to the first pivot rod and (ii) approximately perpendicular to the first pivot rod. The method can comprise attaching the second pivot rod to an arrow mount. The method can comprise attaching a first directional indicator to a first arrow connector of the arrow mount to thereby cause the first directional indicator to point in a first direction, attaching a second directional indicator to a second arrow connector of the arrow mount to thereby cause the first directional indicator to point in a second direction that is approximately perpendicular to the first direction, and attaching a third directional indicator to a third arrow connector of the arrow mount to thereby cause the third directional indicator to point in a third direction is that approximately perpendicular to the first direction and approximately perpendicular to the second direction.

Attaching the pivot mount to the base can comprise: attaching a first pivot mount portion to the base; attaching a second pivot mount portion to the base; and attaching the second pivot mount portion to the first pivot mount portion to thereby form the pivot mount.

Attaching the second pivot rod to the arrow mount can comprise: attaching a first end of the second pivot rod to a third pivot recess of a first arrow mount portion; attaching a second end of the second pivot rod to a fourth pivot recess of a second arrow mount portion; and attaching the first arrow mount portion to the second arrow mount portion to thereby form the arrow mount.

The above and further features of the disclosed systems and methods will be recognized from the following detailed descriptions and drawings of various embodiments.

### BRIEF DESCRIPTION OF THE FIGURES

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1A illustrates a vector measuring device according to various embodiments of the present disclosure.

FIG. 1B illustrates a vector measuring device according to various embodiments of the present disclosure.

FIG. 2A illustrates a base of a vector measuring device according to various embodiments of the present disclosure.

FIG. 2B illustrates a base of a vector measuring device according to various embodiments of the present disclosure.

FIG. 3A illustrates a part of a pivot mount according to various embodiments of the present disclosure.

FIG. 3B illustrates a part of a pivot mount according to various embodiments of the present disclosure.

FIG. 4A illustrates a part of a pivot mount according to various embodiments of the present disclosure.

FIG. 4B illustrates a part of a pivot mount according to various embodiments of the present disclosure.

FIG. 5A illustrates a mount pivot according to various embodiments of the present disclosure.

FIG. 5B illustrates a mount pivot according to various embodiments of the present disclosure.

FIG. 6A illustrates a mount support according to various embodiments of the present disclosure.

FIG. 6B illustrates a mount support according to various embodiments of the present disclosure.

FIG. 7A illustrates an arrow mount according to various embodiments of the present disclosure.

FIG. 7B illustrates an arrow mount according to various embodiments of the present disclosure.

FIG. 7C illustrates an arrow mount according to various embodiments of the present disclosure.

FIG. 7D illustrates an arrow mount according to various embodiments of the present disclosure.

FIG. 8A illustrates a detachable arrow according to various embodiments of the present disclosure.

FIG. 8B illustrates a detachable arrow according to various embodiments of the present disclosure.

FIG. 9A illustrates a detachable arrow according to various embodiments of the present disclosure.

FIG. 9B illustrates a detachable arrow according to various embodiments of the present disclosure.

FIG. 10 illustrates a vector measuring process according to various embodiments of the present disclosure.

FIG. 11 illustrates a vector measuring device assembly process according to various embodiments of the present disclosure.

### DETAILED DESCRIPTION OF THE FIGURES

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

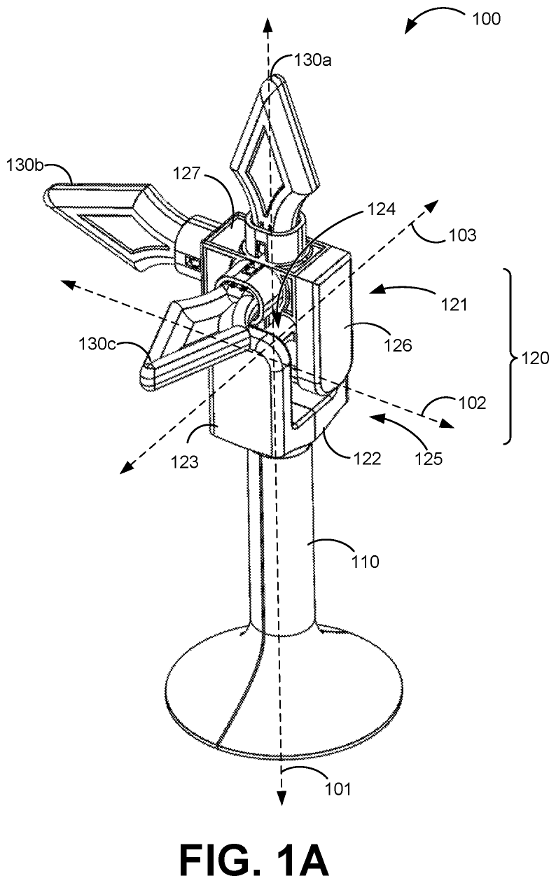

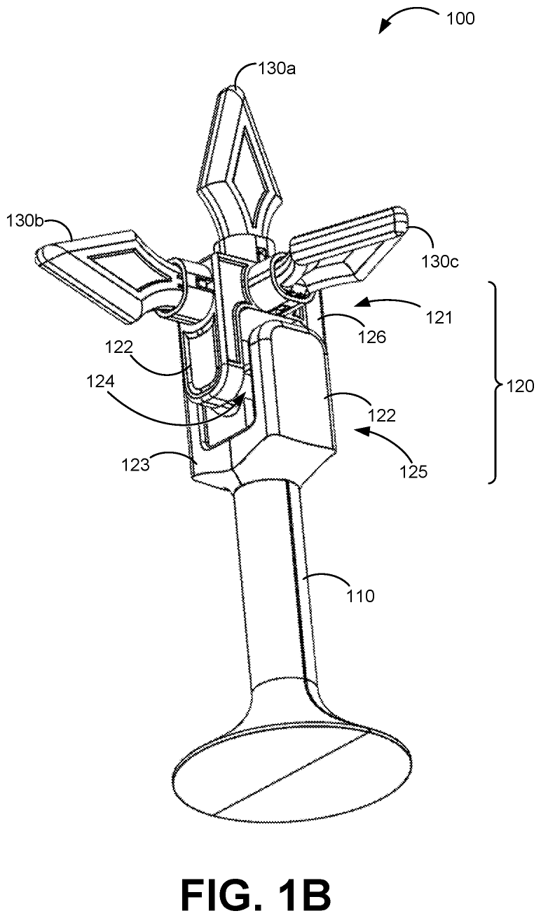

Referring now to the figures, for the purposes of example and explanation of the fundamental processes and components of the disclosed systems and processes, reference is made to FIGS. 1A and 1B, which illustrate an exemplary vector measuring device 100. As will be understood and appreciated, the vector measuring device 100 shown in FIGS. 1A-9B represent merely one approach or embodiment of the present system, and other aspects are used according to various embodiments of the present system.

The vector measuring device 100 can a base 110, a pivot assembly 120, and a plurality of directional indicators, such as a plurality of arrows 130. For example, the device 100 can include three arrows, such as two input arrows 130a, 130b (which can both correspond to the corresponding direction of an input vector) and one resultant arrow 130c (which can indicate the direction of the resultant vector when the two input vectors are multiplied together). The pivot assembly 120 can be configured to move the arrows 130 within three-dimensional (3D) space to various different positions, locations, configurations, or the like, with respect to the base 110. For example, the pivot assembly 120 can be configured to rotate (e.g., 360 degrees) about first axis 101, which can be parallel to a longitudinal central axis of the base 110 (or can itself be the longitudinal central axis of the base 110). Alternatively or in addition, the pivot assembly 120 can rotate about a second axis 102 that is generally perpendicular to the first axis. Alternatively or in addition, the pivot assembly 120 can rotate about a third axis 103 that is generally perpendicular to the first axis 101 and the second axis 102. The second axis 102 and the third axis 103 can intersect the first axis 101. The second axis 102 can intersect the third axis 103, or the second axis 102 can be offset a distance from the third axis, as illustrated in FIG. 1A, for example.

As described more fully herein, the pivot assembly 120 can include a pivot mount 121, a pivot portion 124, and an arrow mount 125. The pivot mount 121 can comprise a first pivot mount portion 122 and a second pivot mount portion 123, and/or the arrow mount 125 can comprise a first arrow mount portion 126 and a second arrow mount portion 127. Regardless, a first end of the pivot mount 121 can attach (e.g., rotatably attach) to the base 110, a second end of the pivot mount 121 can attach (e.g., rotatably attach) to a pivot portion 124 of the pivot assembly 120, and the arrow mount 125 can attach (e.g., rotatably attach) to the pivot portion 124.

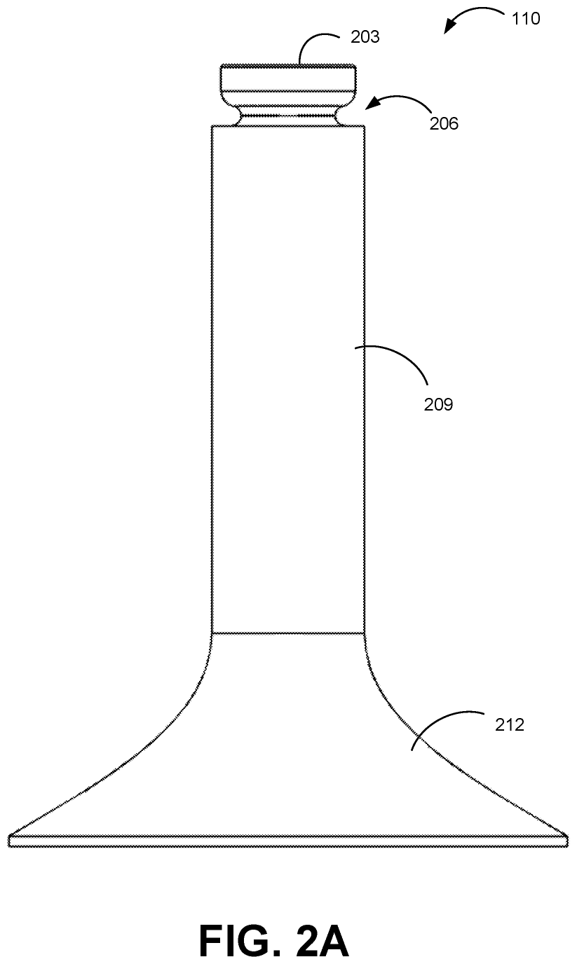

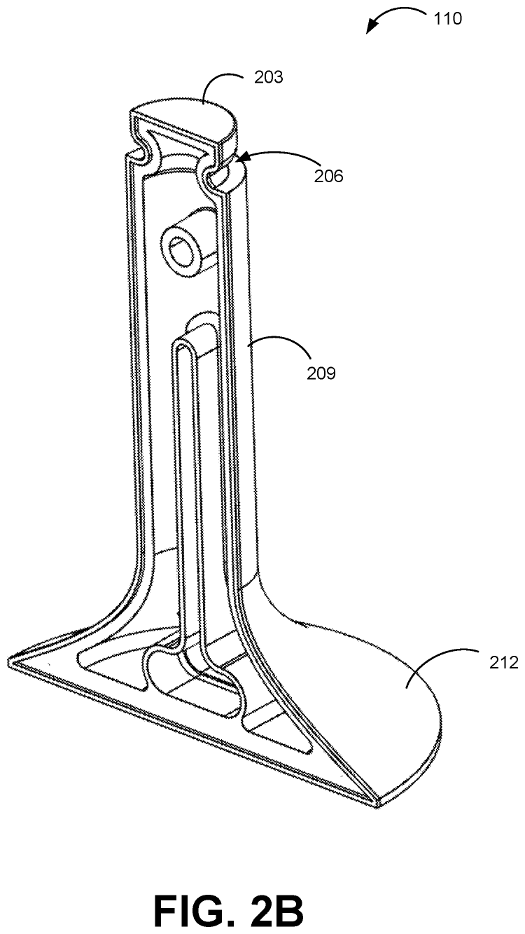

Referring now to FIGS. 2A and 2B, shown is an exemplary view of the base 110. The base 100 can have a generally longitudinal shape and can include a rod 209. The rod 209 can have a length that is greater that its width. The rod 209 can have a generally cylindrical shape (e.g., a generally circular cross-sectional shape). Alternatively, the rod 209 can have a cross-sectional shape that is generally square, generally rectangular, or that has any other suitable shape that can accommodate the functionality described. The rod 209 can be dimensioned to function as a grip or handle (e.g., a length that is approximately equal to a human hand, a diameter or width that is approximately equal to the grip of a human hand).

The base 110 can have a first end and a second end, and the base 110 can include a foundation 212 located at the first end of the base 110. The foundation 212 can be flared with respect to the rod 209. Stated differently, the diameter (or width) of the foundation can increase with the distance from the rod 209. The foundation 212 can have a cross-sectional shape that is generally in the shape of a circle, a square, a rectangle, or any other shape. The foundation 212 can support the base 110. The foundation 212 can have a generally flat bottom surface, which can be configured to support and/or maintain the device 100 in a standing and/or upright position on a base surface (not shown). For example, the foundation 212 can support the base 110 by stabilizing the base 110 when the device 100 is in use. The foundation 212 can keep the vector measuring device 100 from falling while the vector measuring device 100 is being used and/or manipulated or when the vector measuring device 100 is being stored. Alternatively or in addition, the foundation 212 can be weighted to lower the center of mass of the device 100, which can help to prevent the vector measuring device 100 from tipping over.

The base 100 can include a recessed ring 206. The recessed ring 206 can be located at or near the second end of the rod 209, which can be opposite from the first end of the rod (e.g., where the foundation 212 is located). The recessed ring 206 can provide an annular channel about which the pivot assembly 120 can rotate relative to the base 110. For example, a portion of the pivot mount 121 (e.g., a portion of the first pivot mount portion 122 and/or a portion of the second pivot mount portion 123) can extend at least partially into the recessed ring 206. Alternatively or in addition, a portion of the pivot mount 121 (e.g., a portion of the first pivot mount portion 122 and/or a portion of the second pivot mount portion 123) can snap into, slide into, or screw onto the recessed ring 206. Alternatively or in addition, the base 110 (e.g., the recessed ring 206, the connection nodule 203) can include one or more magnets (and/or one or more ferrous material pieces) to attach the base 110 to the pivot mount 121 (e.g., by magnetically interacting with one or more magnets and/or ferrous material pieces of the pivot mount 121).

The base 110 can include a connection nodule 203. The connection nodule 203 can be located at the second end of the rod 209 (e.g., opposite from the foundation 212). The connection nodule 203 can be nearer the terminal edge of the second end than the recessed ring 206 (e.g., farther from the foundation 212 than the recessed ring 206). The connection nodule 203 can be rounded. The connection nodule 203 can have a cross-sectional shape that is generally in the shape of a circle, a square, a rectangular, or any other suitable shape. The cross-sectional shape and/or cross-sectional dimensions of the connection nodule 203 can be the same cross-sectional shape and/or cross-sectional dimensions as the rod 209. Alternatively or in addition, the connection nodule 203 can have a cross-sectional shape that is different from the cross-sectional shape of the rod 209 and/or can have one or more cross-sectional dimensions that is different from one or more cross-sectional dimensions of the rod 209. The connection nodule 203 can help to maintain connection between the base 110 and the pivot mount 121. For example, connection nodule 203 can interface with one or more recessed portions of the pivot mount 121, which can help ensure the pivot mount 121 remains connected to the base 121.

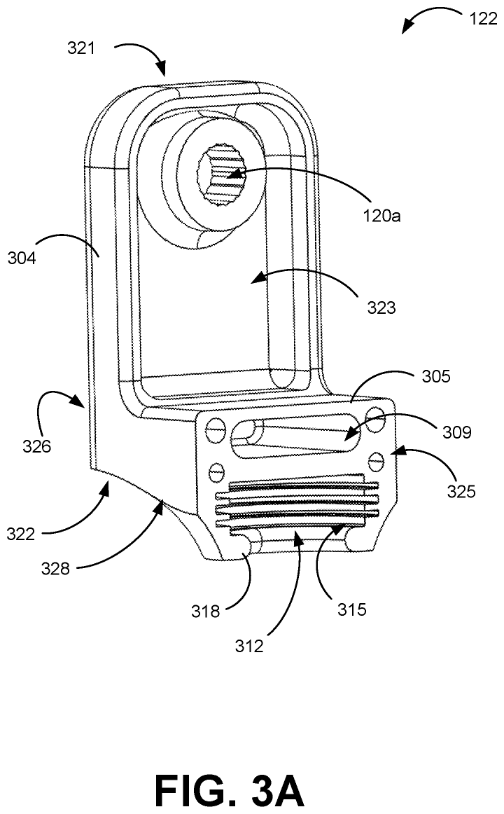

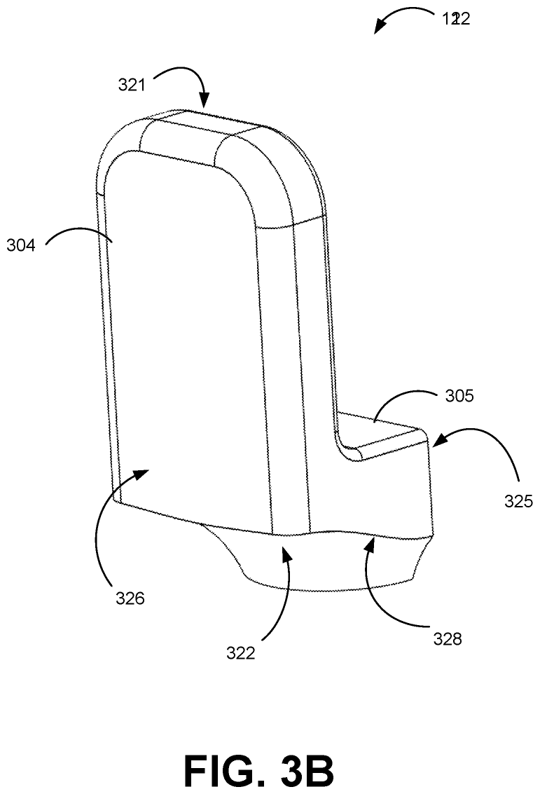

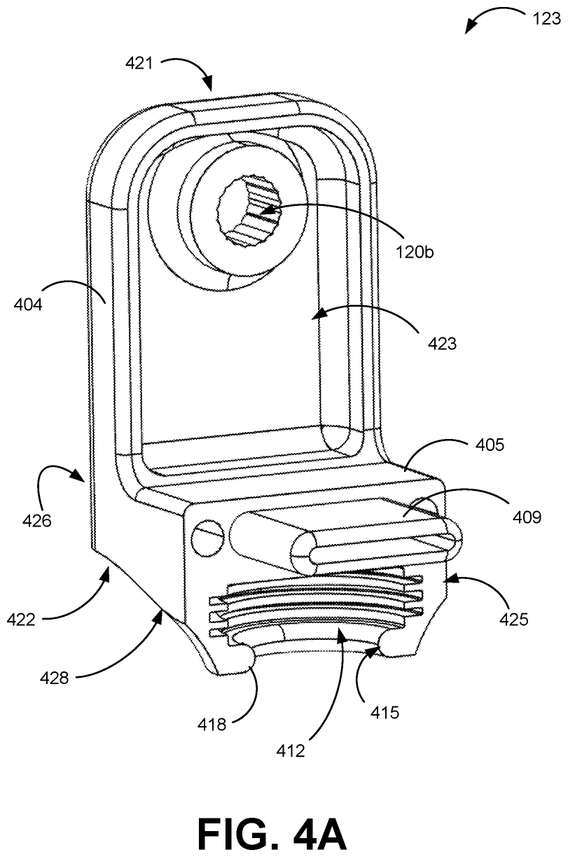

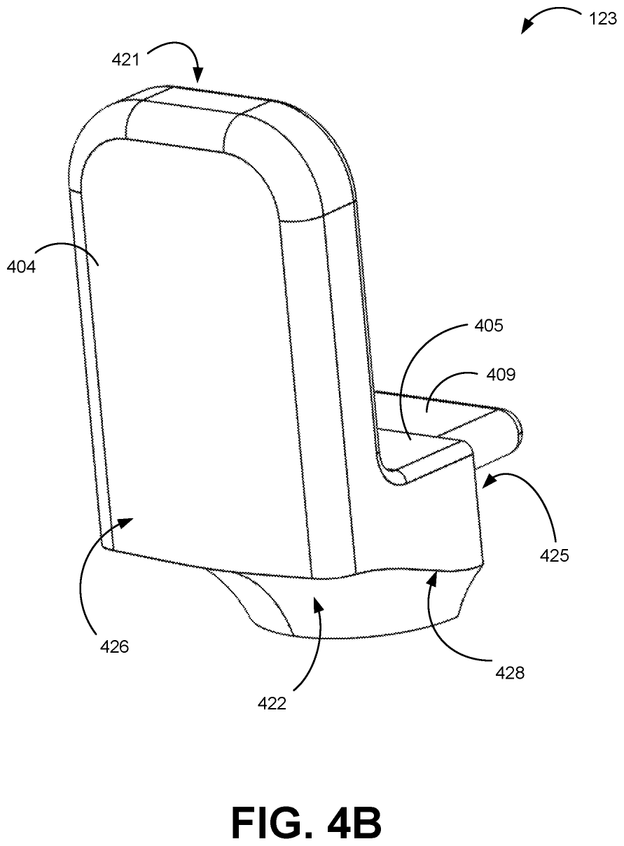

The pivot mount 121 can comprise a single piece of material. For example, the pivot mount 121 can comprise an elastically deformable material and can be press-fitted onto the base 110 (e.g., at the connection nodule 203 and/or the recessed ring 206). Alternatively, the pivot mount 121 can comprise a plurality of components (e.g., pivot mount portions) that can be assembled to provide the pivot mount 121. For example, the pivot mount 121 can comprise a first pivot mount portion 122 and a second pivot mount portion 123, such as is shown in FIGS. 3A-4B. As discussed more fully herein, certain portions of the first pivot mount portion 122 can interface with, and/or connect to, certain portions of the second pivot mount portion 123, such that the first pivot mount portion 122 and the second pivot mount portion 123 can combine to form the pivot mount 121.

Referring now to FIGS. 3A and 3B, shown is an exemplary view of the first pivot mount portion 122. The first pivot mount portion 122 can have a general L shape. For example, the first pivot mount portion 122 can comprise a first portion 304 generally and a second portion 305. The first portion 304 can have a first end 321, a second end 322, and a first side 323. The second end 322 can be opposite the first end 321. The first side 323 can be adjacent to and in between the first end 321 and the second end 322. The first side 323 can be rectangular. The first side 323 can be square or any other shape that can accomplish the functionality described.

The second portion 305 of the first pivot mount portion 122 can be shorter than the first portion 304. Alternatively and in addition, the second portion 305 can be the same length as or longer than the first portion 304, or any other size that can accomplish the functionality described. The second portion 305 can have a third end 325, a fourth end 326, and a second side 328. The third end 325 can be opposite the fourth end 326. The second side 328 can be adjacent to and between the third end 325 and the fourth end 326. The second side 328 can be rectangular. The second side 328 can be square or any other shape that can accomplish the functionality described.

The first portion 304 can be perpendicular to the second portion 305. The first portion 304 can be joined to the second portion 305 at an approximately ninety-degree angle. The first portion 304 can be joined to the second portion 305 at the second end 322 of the first portion 304. The first portion 304 can be joined to the second portion 305 with the first side 323 perpendicular to and facing the second portion 305. The second portion 305 can be joined to the first portion 304 at the fourth end 326 of the second portion 305. The second portion 305 can be joined to the first portion 304 with the second side 328 perpendicular to and facing away from the first portion 304.

The first pivot mount portion 122 can include a base connection protrusion 318. The base connection protrusion 318 can be located at, on, or near the second side 328 of the second portion 305. Alternatively or in addition, the base connection protrusion 318 can be located at, or, or near the third end 325. The base connection protrusion 318 can have a generally semi-circular cross-sectional shape, such as is illustrated in FIG. 3A. Alternatively, the base connection protrusion 318 can have a cross-sectional shape that is generally rectangular or of any other general shape that can accommodate the functionality described. The base connection protrusion 318 can extend along the same plane as the first side 323, in the opposite direction. The base connection protrusion 318 can have a base connection recess 312. The base connection recess can be a semi-circle, another rounded shape, or any other shape that can accomplish the functionality described. The base connection recess 312 can fit around the connection nodule 203. The base connection recess 312 can have an inward protruding lip 315. The inward protruding lip 315 can be rounded. The inward protruding lip 315 can be squared or any other shape that can accomplish the functionality described. The inward protruding lip 315 can fit inside the recessed ring 206 on the base 110. For example, the inward protruding lip 315 can snap, slide, or otherwise be inserted into the recessed ring 206. The base connection recess 312 can likewise snap, slide, or otherwise be fitted around the connection nodule 203. The inward protruding lip 315 and the base connection recess 312 can attach the first pivot mount portion 122 to the base 110.

Alternatively or in addition, the first pivot mount portion 122 (e.g., the base connection recess 312, the inward protruding lip 315, the base connection protrusion 318) can include one or more magnets and/or ferrous metal pieces that can magnetically interact with the one or more magnets and/or ferrous metal pieces of the base 110.

The base connection protrusion 318 can be configured to extend at least partially into the recessed ring 206 on the base 110. As such, the first pivot mount portion 122 can rotate relative the base 110 (e.g., around or about the connection nodule 203). Alternatively or in addition, the base connection recess 312 can include ridges or an otherwise undulating surface that can increment the rotation of the first pivot mount portion 122 relative to the base 115. For example, the base connection recess 312 can include ridges or an otherwise undulating surface that interface with the surface of the connection nodule 203, thereby causing the first pivot mount portion 122 to rotate relative the base 110 in specific angular increments (e.g., “steps” each corresponding to a specific number of degrees). Alternatively, the base connection protrusion 318 can connect the base 110 such that the first pivot mount portion 122 cannot move relative to the base 110. For example, the base connection recess 312 can be threaded. The base connection recess 312 can be threaded such that the base connection protrusion 318 can screw onto the connection nodule 203 (which can also be threaded), thereby preventing movement of the first pivot mount portion 122 relative to the base 110.

The second portion 305 can have a pivot mount recess 309. The pivot mount recess 309 can be on the third end 325 of the second portion 305. The pivot mount recess 309 can be above the base connection recess 312. The pivot mount recess 309 can have any cross-sectional shape, such as a pill-shape, a rectangle, a square, a circle, or the like. The pivot mount recess 309 can be configured to at least partially receive a pivot mount protrusion 409 of the second pivot mount portion 123, to thereby connect the first pivot mount portion 122 to the second pivot mount portion 123 (e.g., via a friction fit connection)

The first portion 304 can include a pivot reception recess 120a. The pivot reception recess 120a can be located proximate the first end 321 and on the first side 323 of the first portion 304. The pivot reception recess 120a can extend entirely through the first portion 304 or only partially through the first portion 304 (e.g., as illustrated by FIGS. 3A and 3B). The pivot reception recess 120a can be configured to at least partially receive a corresponding pivot connection protrusion 509 of the pivot portion 124, as discussed more fully herein. As such, the first pivot mount portion 122 can be connected to, and rotatable about, the corresponding pivot connection protrusion 509 of the pivot portion 124.

Referring now to FIGS. 4A and 4B, shown is an exemplary view of the second pivot mount portion 123. Similar to the first pivot mount portion 122, the second pivot mount portion 123 can have a general L shape. The second pivot mount portion 123 can be comprised of a first portion 404 and a second portion 405. The first portion 404 can have a first end 421, a second end 422, and a first side 423. The second end 422 can be opposite the first end 421. The first portion 404 can have a first side 423. The first side 423 can be adjacent to and between the first end 421 and the second end 422. The first side 423 can be rectangular. The first side 423 can be square or any other shape that can accomplish the functionality described. The first portion 404 of the second pivot mount portion 123 can be the same size as or similar in size to the first portion 304 of the first pivot mount portion 122. The first side 423 of the second pivot mount portion 123 can be the same size and shape as the first side 323 of the first pivot mount portion 122.

The second portion 405 can be shorter than the first portion 404. Alternatively and in addition, the second portion 405 can be the same length as or longer than the first portion 404, or any other size that can accomplish the functionality described. The second portion 405 can have a third end 425, a fourth end 426, and a second side 428. The third end 425 can be opposite the fourth end 426. The second side 428 can be adjacent to and between the fourth end 426 and the third end 425. The second side 428 can be rectangular. The second side 428 can be square or any other shape that can accomplish the functionality described. The second portion 405 of the second pivot mount portion 123 can be the same size as or similar in size to the second portion 305 of the first pivot mount portion 122. The second side 428 of the second pivot mount portion 123 can be the same size and shape as or a similar size and shape to the second side 328 of the first pivot mount portion 122.

The first portion 404 can be perpendicular to the second portion 405. The first portion 404 can be joined to the second portion 405 at an approximately ninety-degree angle. The first portion 404 can be joined to the first portion 404 at the second end 422. The first portion 404 can be joined to the second portion 405 with the first side 423 perpendicular to and facing the second portion 405. The second portion 405 can be joined to the first portion 404 at the fourth end 426 of the second portion 405. The second portion 405 can be joined to the first portion 404 with the second side 428 perpendicular to and facing away from the first portion 404.

The second pivot mount portion 123 can include a base connection protrusion 418. The base connection protrusion 418 can be located at, on, or near the second side 428 of the second portion 405. Alternatively or in addition, the base connection protrusion 418 can be located at, on, or near the third end 425 of the second portion 405. The base connection protrusion 418 can have a generally semi-circular cross-sectional shape, such as is illustrated in FIG. 4A. Alternatively, the base connection protrusion 418 can have a cross-sectional shape that is generally rectangular or of any other general shape that can accommodate the functionality described. The base connection protrusion 418 can extend along the same plane as the first portion 404, in the opposite direction. The base connection protrusion 418 can have a base connection recess 412. The base connection recess 412 can fit around the connection nodule 203. The base connection recess 412 can have an inward protruding lip 415. The inward protruding lip 415 can be rounded. The inward protruding lip 415 can be squared or any other shape that can accomplish the functionality described. The inward protruding lip 415 can fit inside the recessed ring 206 on the base 115. For example, the inward protruding lip 415 can snap, slide, or otherwise be inserted into the recessed ring 206. The base connection recess 412 can likewise snap, slide, or otherwise be fitted around the connection nodule 203. The inward protruding lip 415 and the base connection recess 412 can attach the second pivot mount portion 123 to the base 110.

Alternatively or in addition, the second pivot mount portion 123 (e.g., the base connection recess 412, the inward protruding lip 415, the base connection protrusion 418) can include one or more magnets and/or ferrous metal pieces that can magnetically interact with the one or more magnets and/or ferrous metal pieces of the base 110.

The base connection protrusion 418 can be configured to extend at least partially into the recessed ring 206 on the base 110. As such, the second pivot mount portion 123 can rotate relative to the base 110 (e.g., around or about the connection nodule 203). Alternatively or in addition, the base connection recess 412 can include ridges or an otherwise undulating surface that interface with the surface of the connection nodule 203, thereby causing the second pivot mount portion 123 to rotate relative the base 110 in specific angular increments (e.g., “steps” each corresponding to a specific number of degrees). Alternatively, the base connection protrusion 418 can connect the base 115 such that the second pivot mount portion 123 cannot move relative to the base 110. For example, the base connection recess 412 can be threaded. The base connection recess 412 can be threaded such that the base connection protrusion 418 can screw onto the connection nodule 203 (which can also be threaded), thereby preventing movement of the second pivot mount portion 123 relative to the base 110.

The second portion 405 can have a pivot mount protrusion 409. The pivot mount protrusion 409 can be above the base connection recess 412. The pivot mount protrusion 409 can be on the third end 325 of the second portion 405. The pivot mount protrusion 409 can have any cross-sectional shape, such as a pill-shape, a rectangle, a square, a circle, or the like. The pivot mount protrusion 409 can connect the second pivot mount portion 123 to the first pivot mount portion 122. The pivot mount protrusion 409 can be configured to extend at least partially into the pivot mount recess 309, to thereby connect the second pivot mount portion 123 to the first pivot mount portion 122 (e.g., via a friction fit connection).

The first portion 404 can include a pivot reception recess 120b. The pivot reception recess 120b can be located on the first side 423 of the first portion 404. The pivot reception recess 120b can be located proximate the first end 421 of the first portion 404. The pivot reception recess 120b can extend entirely through the first portion 404 or only partially through the first portion 404 (e.g., as illustrated by FIGS. 4A and 4B). The pivot reception recess 120b can be configured to at least partially receive a corresponding pivot connection protrusion 509 of the pivot portion 124, as discussed more fully herein. As such, the second pivot mount portion 123 can be connected to, and rotatable about, the corresponding pivot connection protrusion 509 of the pivot portion 124.

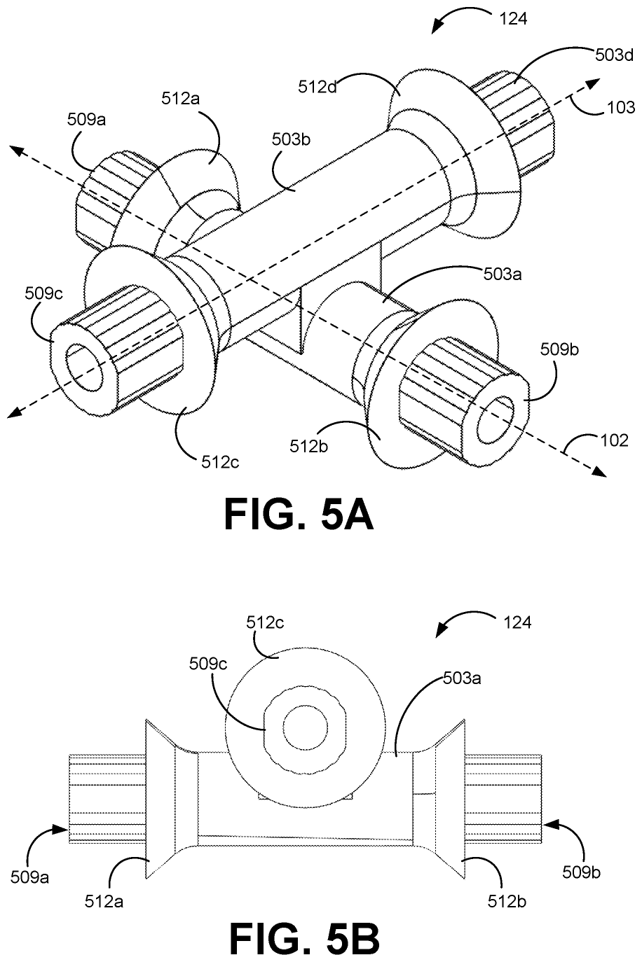

Referring now to FIGS. 5A and 5B, shown is an exemplary view of the pivot portion 124. The pivot portion 124 can include at least two rods 503. The rods 503 can be of the same general shape, or one or more of the rods 503 have a general shape that is different from the general shape of one or more other rods 503. For example, each rod 503 can have a generally cylindrical shape. Alternatively or in addition, a given rod 503 can have a cross-sectional shape that is generally in the shape of a square, a rectangle, or any other shape. As illustrated, the pivot portion 124 can include a first rod 503a that is fixedly attached to a second rod 503b. The first rod 503a can be generally perpendicular to the second rod 503b. The midpoint of the first rod 503a can be joined to the second rod 503b, and/or the midpoint of the second rod 503b can be joined to the first rod 503a Each end of a given rod 503 can include a flared end 512 or any other type of protrusion extending radially outward from the rod 503 and can include a pivot connection protrusion 509 extending axially outward from the flared end 512. As a non-limiting example, the first rod 503a can have two pivot connection protrusions 509a and 509b. The pivot connection protrusions 509a and 509b can be at opposite ends of the first rod 503a. The pivot connection protrusion 509a can extend from the flared end 512a, and the pivot connection protrusion 509b can extend from the flared end 512b. As another example, the second rod 503b can have two pivot connection protrusions 509c and 509d. The pivot connection protrusion 509c and 509d can be at opposite ends of the second rod 503b. The pivot connection protrusion 509c can extend from the flared end 512c, and the pivot connection protrusion 509d can extend from the flared end 512d.

The pivot connection protrusions 509 can have a generally cylindrical shape or can have any other rounded shape that can accomplish the functionality described. The pivot connection protrusions 509 can have circumferential ridges, ribbing, or an otherwise undulating surface. For example, each pivot connection protrusion 509 can be ribbed such that the rotation of the pivot connection protrusion 509 inside a pivot reception recess 120 is incremented by a specific number of degrees determined by the ribbing. The ridges or the like can interface with the surface of a corresponding recess and can correspond to predetermined angular increments, such that a given component (e.g., corresponding to a given recess) can rotate relative the corresponding rod 503 and can “snap” to predetermined angular dispositions relative to the corresponding rod 503. Alternatively or in addition, one or more of the pivot connection protrusions 509 can have a smooth surface. For example, one or more of the pivot connection protrusions 509 can be smooth such that each pivot connection protrusion 509 can rotate freely within a pivot reception recess 120 (e.g., without being subject to any predetermined angular increments).

The pivot connection protrusions 509 can fit inside or otherwise connect to the pivot reception recesses 120 of certain other components, as described more fully herein (e.g., the first pivot mount portion 122, the second pivot mount portion 123, the first arrow mount portion 126, and/or the second arrow mount portion 127). That is to say, the pivot connection protrusions 509 can connect the pivot portion 124 to the first pivot mount portion 122 and the second pivot mount portion 123. The pivot connection protrusions 509 can connect the pivot portion 124 to the first arrow mount portion 126 and the second arrow mount portion 127. In any event, the mating recess (e.g., pivot reception recess 120) of such component(s) can be generally round and/or can include ridges, ribbing, or an otherwise undulating surface to interface with the circumferential surface of the corresponding pivot connection protrusion 509. Alternatively or in addition, one or more pivot connection protrusions 509 and/or one or more pivot reception recesses 120 can include one or more magnets and/or ferrous metal pieces to magnetically interact with one or more magnets and/or ferrous metal pieces of a corresponding pivot reception recess 120 (e.g., of any given component including a pivot reception recess 120) to thereby “snap” any rotation therebetween to predetermined angular increments and/or to can hold the corresponding component in a desired angular position relative to the corresponding rod 503.

As more specific examples, the pivot connection protrusion 509a can connect the first rod 503a to the pivot reception recess 120a of the first pivot mount portion 122, the pivot connection protrusion 509b can connect the first rod 503a to the pivot reception recess 120b of the second pivot mount portion 123, the pivot connection protrusion 509c can connect the third rod 503c to the pivot reception recess 120c of the first arrow mount portion 126, and the pivot connection protrusion 509d can connect the fourth rod 503d to the pivot reception recess 120d of the second arrow mount portion 127.

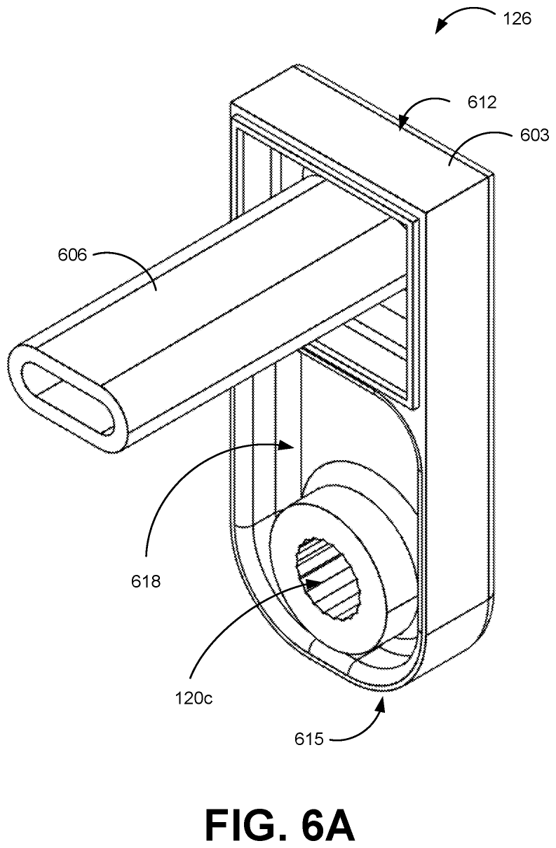

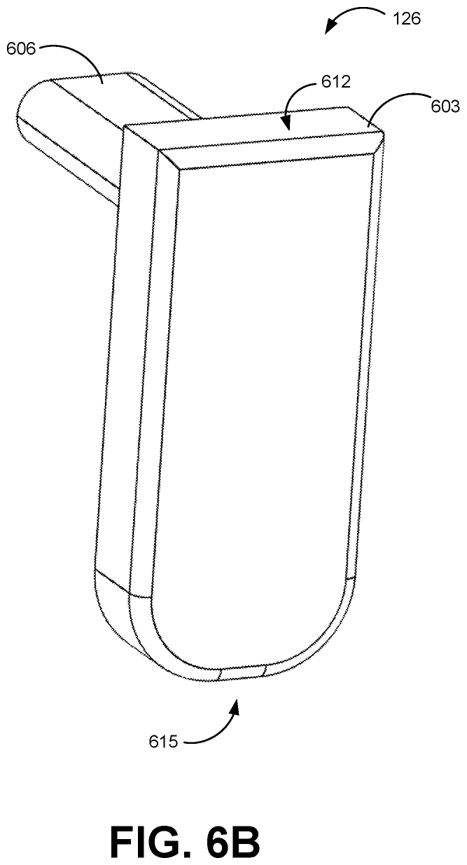

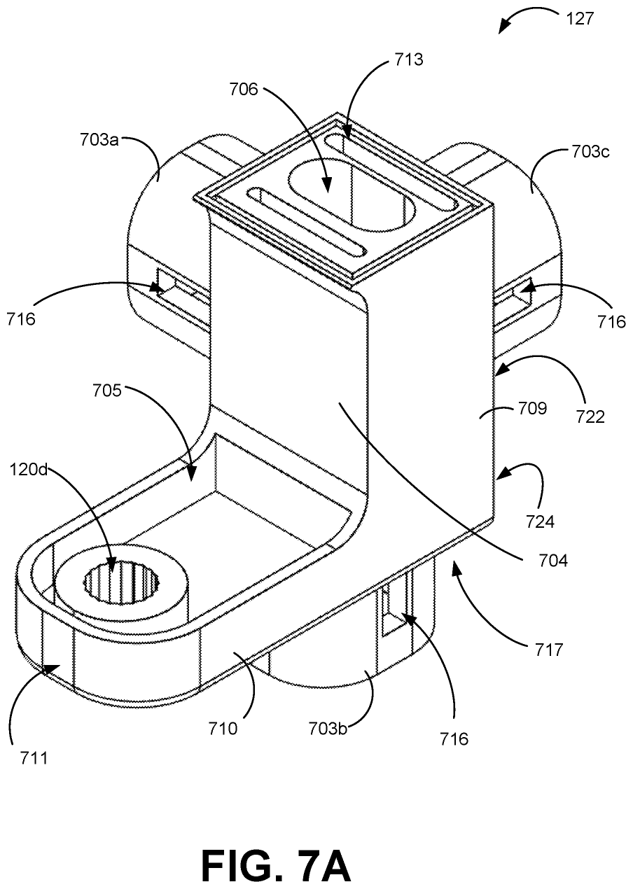

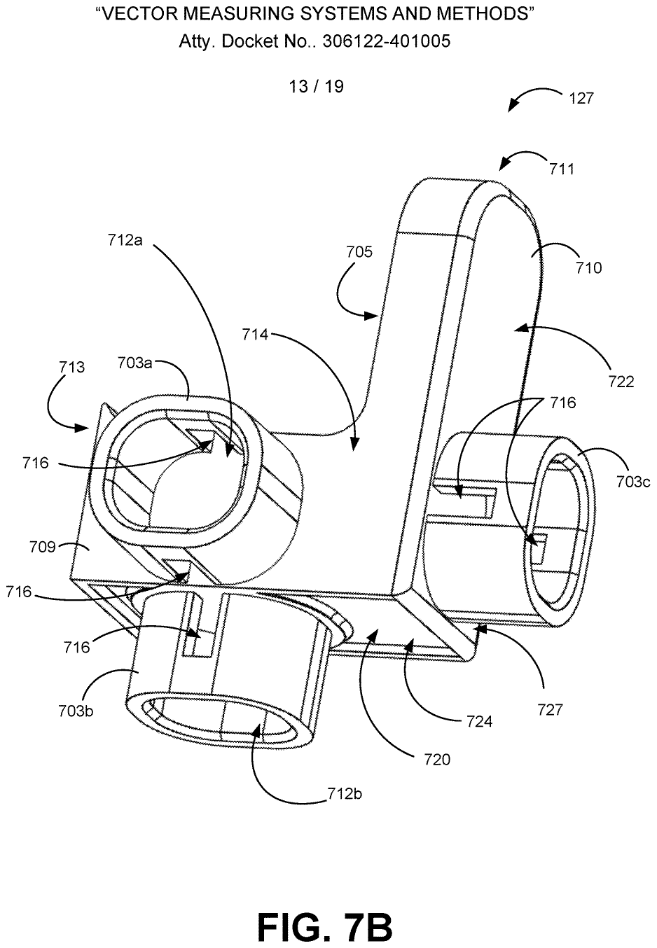

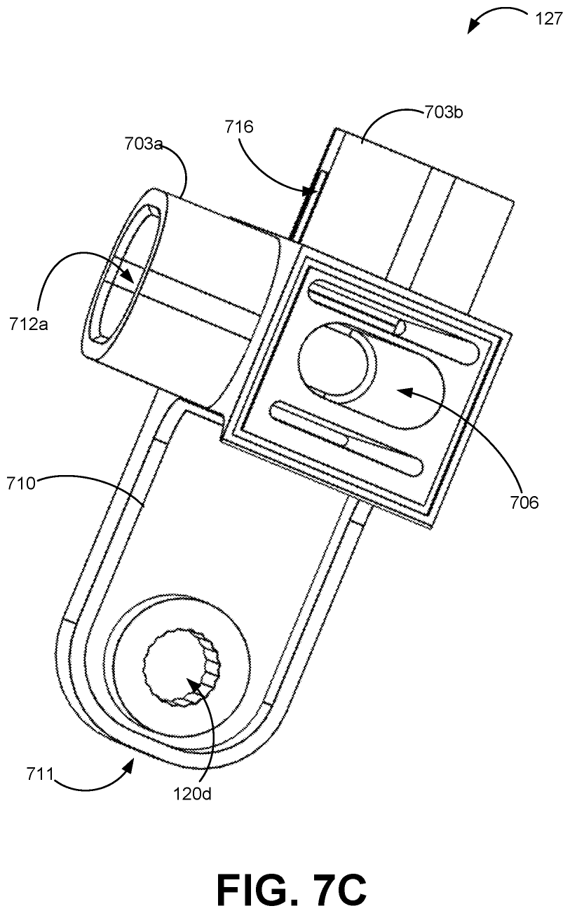

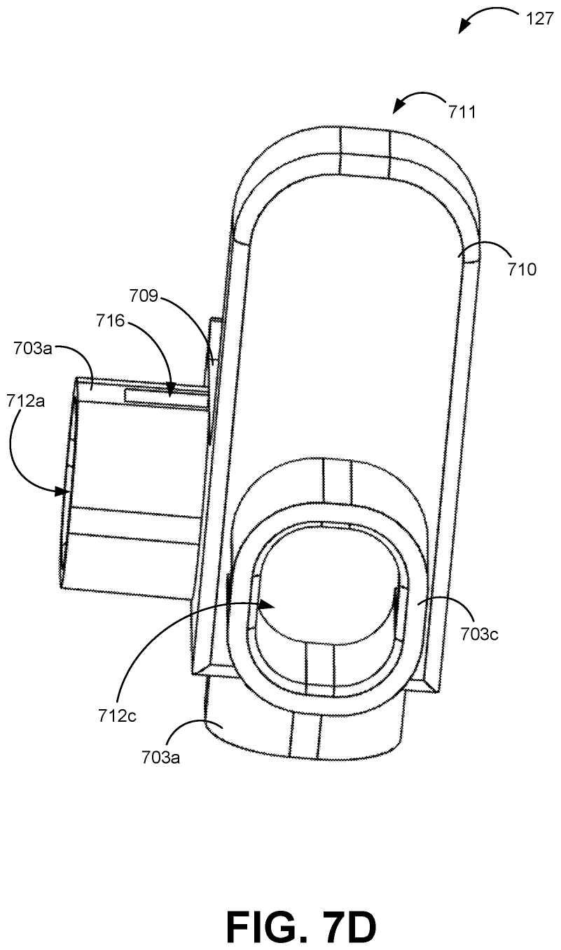

As previously discussed, the vector measuring device 100 can include an arrow mount 125. The arrow mount 125 can comprise a single piece of material. For example, the arrow mount 125 can comprise an elastically deformable material and can attach to the pivot portion 124 (e.g., via press fit, via bending and/or deformation of one or more portions of the arrow mount 125). Alternatively, the pivot mount 121 can comprise a plurality of components (e.g., arrow mount portions) that can be assembled to provide the arrow mount 125. For example, the arrow mount 125 can comprise a first arrow mount portion 126 and a second arrow mount portion 127, such as is shown in FIGS. 6A-7D. As discussed more fully herein, certain portions of the first arrow mount portion 126 can interface with, and/or connect to, certain portions of the second arrow mount portion 127, such that the first arrow mount portion 126 and the second arrow mount portion 127 can combine to form the arrow mount 125.

Referring now to FIGS. 6A and 6B, shown is an exemplary view of the first arrow mount portion 126. The first arrow mount portion 126 can have a body 603, and the body 603 can have a cross-section that is generally in the shape of a rectangle, a square, or any other shape. The body 603 can have one or more rounded edges. For example, the body 603 can include one or more squared corners, one or more rounded corners, one or more corners having a different profile, or any combination thereof. The body 603 can have a first end 615, a second end 612, and an interior side 618. The second end 612 can be located opposite from the first end 615. The interior side 618 can be located between and adjacent to the second end 612 and the first end 615. The body 603 can include a pivot reception recess 120c proximate the first end 615. The pivot reception recess 120c can be located on the interior side 618 and can either extend fully through the body 603 or only partially therethrough (e.g., as illustrated in FIGS. 6A and 6B). The pivot reception recess 120c can be configured to at least partially receive a pivot connection protrusion 509 to thereby connect the first arrow mount portion 126 to the pivot portion 124.

The body 603 can have an attachment protrusion 606 extending from the interior side 618. The attachment protrusion 606 can have a cross-section that is generally in the shape of a pill-shape, a rectangle, a square, a circle, or any other shape. The attachment protrusion 606 can be hollow, or the attachment protrusion 606 can be solid. The attachment protrusion 606 can be configured to extend at least partially into the attachment recess 706 of the second arrow mount portion 127. Alternatively or in addition, the attachment protrusion 606 and/or the attachment recess 706 can be shaped and dimensioned such that at least a portion of the attachment protrusion 606 snugly fits inside the attachment recess 706. Accordingly, the attachment protrusion 606 can connect the first arrow mount portion 126 to the second arrow mount portion 127 (e.g., via a friction fit). Alternatively or in addition, the attachment protrusion 606 can slide, snap, or otherwise be inserted into and/or attached to the attachment recess 706. The attachment protrusion 606 can attach the first arrow mount portion 126 and the second arrow mount portion 127 together. Alternatively or in addition, the attachment protrusion 606 and/or the attachment recess 706 can include one or more magnets and/or ferrous metal pieces such that the attachment protrusion 606 and the attachment recess 706 can magnetically interact to maintain connection and/or attachment between the first arrow mount portion 126 and the second arrow mount portion 127. Alternatively or in addition, the first arrow mount portion 126 and the second arrow mount portion 127 can connect together via one or more fasteners, or any other connection or attachment device.

Referring now to FIGS. 7A-7D, shown is an exemplary view of the second arrow mount portion 127. The second arrow mount portion 127 can have a general L shape. The second arrow mount portion 127 can include a first portion 709 and a second portion 710. The first portion 709 can have a first end 713, a second end 727, a first side 704, a second side 714, and a third side 720. The second end 727 can be located the first portion 709 opposite from the first end 713. The first side 704 can be adjacent to and between the first end 713 and the second end 727. The first portion 709 can be generally rectangular, square, or any other shape. The first portion 709 can have rounded edges, squared edges, edges of any other shape or profile, or any combination thereof. The first portion 709 can have a flared edge at the first end 713 (e.g., a lip extending away from the first end 713).

The second portion 710 can have a third end 711, a third fourth end 724, a fourth side 705, and a fifth side 722. The fourth end 724 can be located on the second portion 710 opposite from the third end 711. The fourth side 705 can be between and adjacent to the third end 711 and the fourth end 724. The second portion 710 can be rectangular, square, or any other shape. The second portion 710 can have rounded edges, square edges, edges of any other shape or profile, or any combination thereof.

The first portion 709 can be perpendicular to the second portion 710. The first portion 709 can be joined to the second portion 710 at an approximately ninety-degree angle. The first portion 709 can be joined to the second portion 710 at the second end 727 of the first portion 709. The first portion 709 can be joined to the second portion 710 with the first side 704 perpendicular to and facing the second portion 710. The second portion 710 can be joined to the first portion 709 at the fourth end 724 of the second portion 710. The second portion 710 can be joined to the first portion 709 with the fourth side 705 perpendicular to and facing the first portion 709.

The second portion 710 can have a pivot reception recess 120d. The pivot reception recess 120d can be at or near the third end 711 of the second portion 710. The pivot reception recess 120d can be on the fourth side 705 of the second portion 710. The pivot reception recess 120d can connect the second arrow mount portion 127 to the pivot portion 124. For example, the pivot reception recess 120d can connect to a pivot connection protrusion 509.

Referring now to FIG. 7B, shown is an exemplary view of the second arrow mount portion 127. The first portion 709 can have a second side 714 and a third side 720. The first second side 714 can be between and adjacent to the first end 713 and the second end 727. The second side 714 can be adjacent and perpendicular to the first side 704 of the second portion 710. The third side 720 of the first portion 709 can be between and adjacent to the first end 713 and the second end 727 of the first portion 709. The third side 720 can be adjacent and perpendicular to the second side 714. The third side 720 can be parallel to the first side 704.

The second portion 710 can have a fifth side 722. The fifth side 722 can be between and adjacent to the third end 711 and the fourth end 724. The fifth side 722 can be parallel to the fourth side 705 of the second portion 710. The fifth side 722 can be perpendicular to the third side 720 of the first portion 709.

The second arrow mount portion 127 can have three arrow connection points 703. The arrow connection points 703 can be square, round, rectangular, or any other shape that can accomplish the functionality described. The arrow connection points 703 can have rounded corners, square corners, a combination of square and rounded corners, or any other shape corner that can accomplish the functionality described. The arrow connection points 703 can be hollow. Each arrow connection point 703 can contain an arrow reception recess 712. The arrow reception recess 712 can be round, square, rectangular, or any other shape that can accomplish the functionality described. Each arrow connection point 703 can include one or more detent recesses 716. The detent recesses 716 can be a cutout from the arrow connection point 703. The detent recesses 716 can be rectangular, square, round, or any other shape that can accomplish the functionality described. The detent recesses 716 can be symmetrically or asymmetrically placed around the arrow connection points 703.

Each arrow connection point 703 can connect the second arrow mount portion 127 to an arrow 103. For example, the arrow connection point 703 can slide around, snap onto, or screw onto a tail 809 of an arrow 103. The arrow connection point 703 can hold the arrow 103. Alternatively and in addition, the arrow connection point 703 can slide around or snap onto an arrow tail 809 and the detent recesses 716 can accommodate the detent protrusions 812 on the arrow tail 809. The detent protrusions 812 can be depressed to be inserted into the arrow connection point 703 and can spring open to fit inside the detent recesses 716 and hold the arrow 103 in place. In some embodiments, the arrow reception recess 712 can contain a magnet. The magnet in the arrow reception recess 712 can connect to a magnet in a tail 809 of an arrow 103. The arrow reception recess 712 can contain a magnet to hold an arrow 103 in place in the arrow connection points 703. In some other embodiments, the arrow reception recess 712 can contain a hook and loop fastener, a snap fastener, or another connection device that can connect to a corresponding device on a tail 809 of an arrow 103, which can hold an arrow 103 in place in the arrow connection point 703.

The first portion 709 can have a first arrow connection point 703a and a second arrow connection point 703b. The first arrow connection point 703a can be on the second side 714 of the first portion 709. The second arrow connection point 703b can be on the third side 720 of the first portion 709. The second arrow connection point 703b can be perpendicular to the first arrow connection point 703a.

The second portion 710 can have a third arrow connection point 703c. The third arrow connection point 703c can be on the fifth side 722 of the second portion 710. The third arrow connection point 703c can be at or near the fourth end 724 of the fifth side 722. The third arrow connection point 703c can be perpendicular to the first arrow connection point 703a and the second arrow connection point 703b.

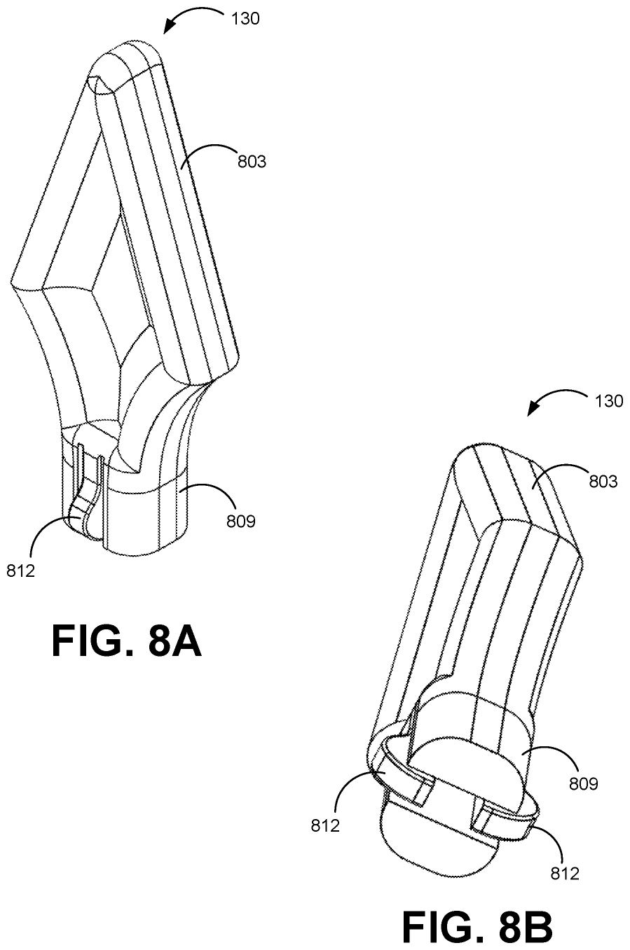

Referring now to FIGS. 8A and 8B, shown is an exemplary view of the arrow 103, or other directional indicator. The arrow 103 can include a generally triangular shape 803 and a tail 809. The tail 809 can extend from the base of the generally triangular shape 803, opposite the directional indicator. The tail 809 can have a cross-section that is generally in the shape of a square, a rectangular, a circle, or any other shape. The tail 809 can have rounded corners, squared corners, corners of any other profile, or any combination thereof.

The tail 809 can include one or more detent protrusions 812. The detent protrusions 812 can be round, square, rectangular, or any other shape. The tail 809 of a given arrow 130 can be configured to attach to a corresponding arrow reception recess 712 (e.g., insert at least partially into a corresponding arrow reception recess 712). Alternatively or in addition, the tail 809 of a given arrow 130 can be configured to detachably attach to a corresponding arrow reception recess 712, such as via a snap fit connection. For example, and as illustrated in FIGS. 8A and 8B, a given tail 809 can include one or more snap joints and/or detent protrusions 812. Each detent protrusion 812 can be elastically deformable and can be biased to a closed position (e.g., via torsion or some other force). The detent protrusion 812 can be forced to a deformed position during assembly (e.g., when the tail 809 is inserted into an arrow reception recess 712), and the detent protrusion 812 can return to the closed position when the detent protrusion 812 becomes aligned with a corresponding detent recess 716. Thus, a given detent protrusion 812 can extend at least partially into (and/or be at least partially received by) a corresponding detent recess 716 when the corresponding arrow 130 is attached to the arrow mount 125. As illustrated, a given arrow 130 can include one or more detent protrusions 812, and the arrow mount 125 can include one or more corresponding detent recesses 716 for each arrow (e.g., via the arrow mount recesses 712). Alternatively or in addition, a given arrow 130 can include one or more detent recesses 716, and the arrow mount 125 can include one or more corresponding detent protrusion 812. Alternatively or in addition, the tail 809 can be connected to the arrow mount 125 via any fastener, adhesive, or any other connection method, material, device, or the like. For example, the tail 809 of a given arrow 130 and the arrow mount 125 (e.g., one or more of the arrow reception recess 712) can each include one or more magnets and/or ferrous metal pieces, such that the arow 130 can be magnetically attached to the arrow mount 125.

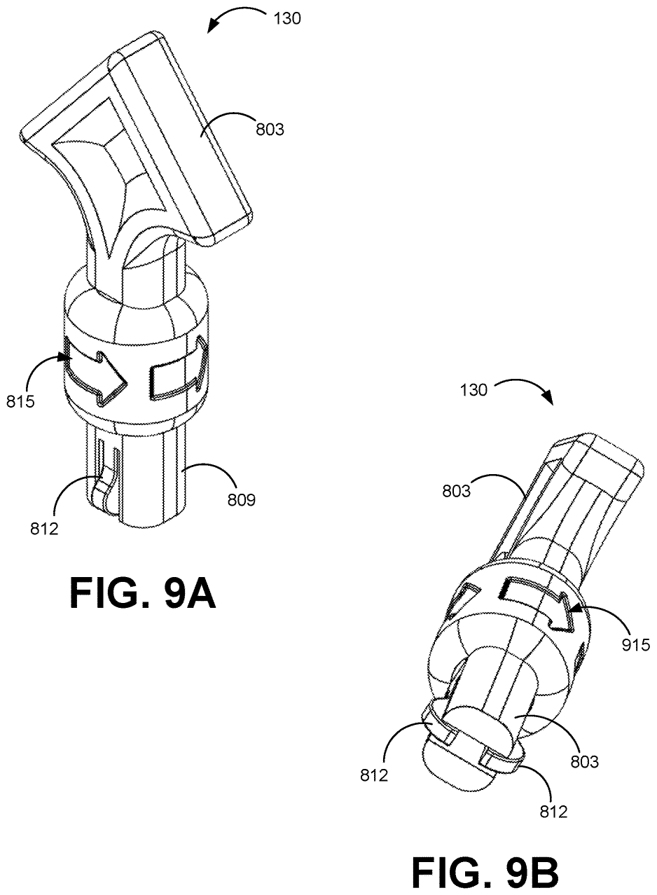

Referring now to FIGS. 9A and 9B, shown is an exemplary view of an alternative design for an arrow 130, which can include a rotational indicator 915. The rotational indicator 915 can include one or more arrows pointing in a clockwise direction (e.g., as viewed from the terminal end of the tail 809 of the arrow 130). The rotational indicator 915 can comprise a sticker, paint, ink, or one or more recesses within the material of the arrow 130 itself, as non-limiting examples. The rotational indicator 915 can help guide a user to properly utilize the vector measuring device 100.

Various components of the vector measuring device 100 has been heretofore described, and it is to be understood that any such component can be made from and/or comprise any material (e.g., any rigid material), such as plastic, metal, wood, or the like, or any combination thereof. Furthermore, any given component of the vector measuring device 100 can be made and/or manufactured by any relevant or useful manufacturing process or combination of processes, such as molding (e.g., injection molding, compression molding, blow molding, rotational molding, or thermoforming), machining, carving, routing, milling, turning, drilling, grinding, casting, extruding, forging, sintering, stamping, die cutting, laser cutting, water-jet cutting, additive manufacturing (e.g., three-dimensional printing, fused deposition modeling, stereolithography, selective laser sintering), laminating, bonding (e.g., adhesive bonding, solvent welding), fastening, over-molding, insert molding, assembly, finishing processing (e.g., polishing, coating, painting, printing, surface texturing), or the like, or any combination thereof, as non-limiting examples.

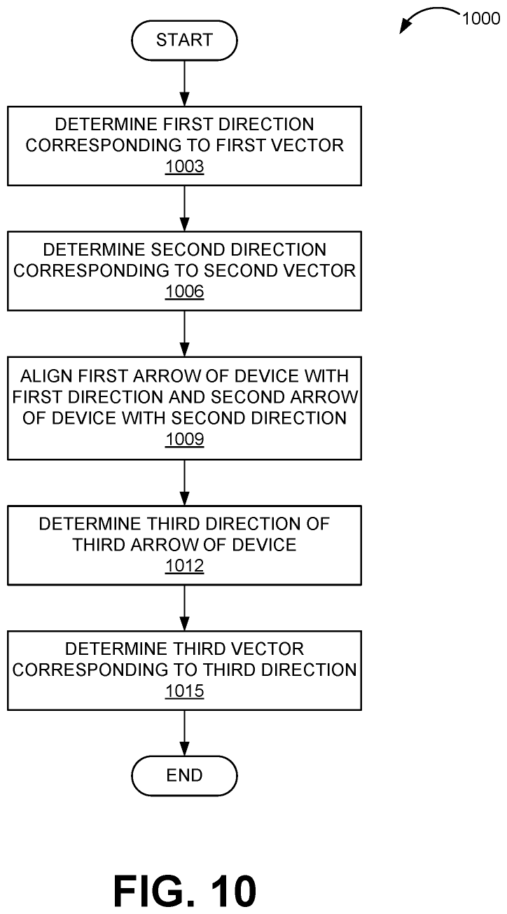

Referring now to FIG. 10, shown is an exemplary vector measuring process 1000. The process 1000 can relate to using the vector measuring device 100. At step 1003, the process 1000 can include determining a first direction corresponding to a first vector. For example, a problem (e.g., a mathematical problem to be solved, such as by multiplying together two vectors) can present a first vector having a first direction. At step 1006, the process 1000 can include determining a second direction corresponding to a second vector. For example, the problem can present a second vector having a second direction. At step 1009, the process 1000 can include aligning a first arrow 130 of a device 100 with the first direction and a second arrow 130 of the device 100 with the second direction. At step 1012, the process 1000 can include determining (e.g., observing) a third direction of the third arrow 130c. For example, determining the third direction can include observing the third direction, which can be automatically indicated by third arrow 130c of the vector measuring device 100 following proper alignment of the first arrow 130a to the first direction and the second arrow 130a to the second direction. At step 1015, the process 1000 can include determining the direction to be the direction of the third vector, which can be the vector resulting from the multiplication of the first vector by the second vector.

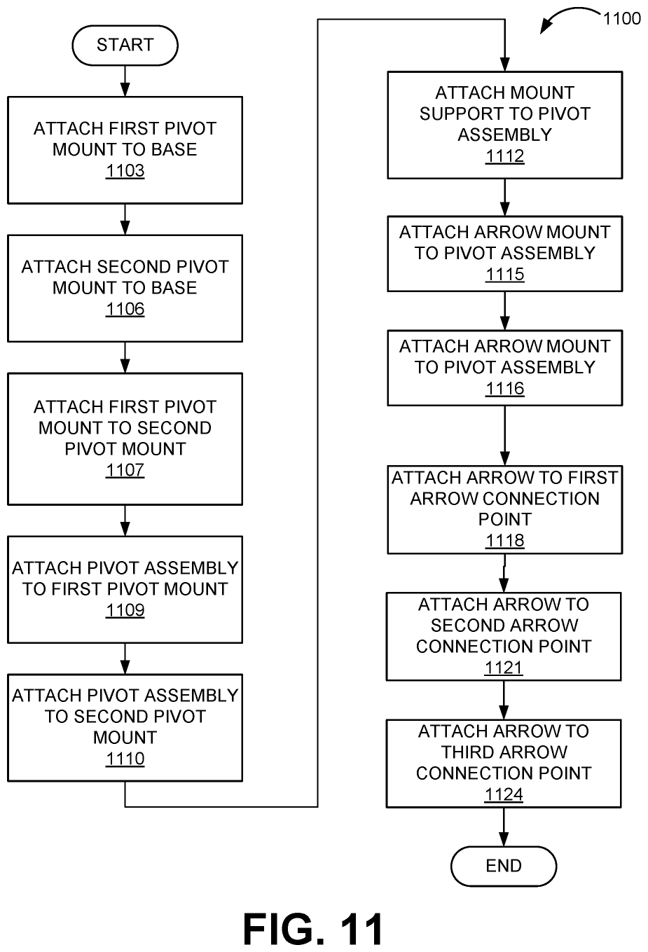

Referring now to FIG. 11, shown is an exemplary vector measuring device assembly process 1100. At step 1103, the process 1100 can include attaching a first pivot mount portion 122 to a base 110. For example, a first pivot mount portion 122 can be attached to the base 110 by sliding, snapping, or otherwise connecting the first pivot mount portion 122 to the base 110 (e.g., by inserting an inward protruding lip 315 of the first pivot mount portion 122 into a recessed ring 206 of the base 110).

At step 1106, the process 1100 can include attaching a second pivot mount portion 123 to the base 110. For example, a second pivot mount portion 123 can be attached to the base 110 by sliding, snapping, or otherwise connecting the second pivot mount portion 123 to the base 110 (e.g., by inserting an inward protruding lip 415 of the second pivot mount portion 123 into the recessed ring 206 of the base 110).

At step 1107, the process 1100 can include attaching a second pivot mount portion 123 to a first pivot mount portion 122 (e.g., to provide a pivot mount 121). For example, a second pivot mount portion 123 can be attached to a first pivot mount portion 122 by inserting a pivot mount protrusion 409 (e.g., of the second pivot mount portion 123) into a pivot mount recess 309 (e.g., of the first pivot mount portion).

Alternatively or in addition, the method 1100 can include assembling the pivot mount 121 (e.g., as described with respect to step 1107) and inserting an inward protruding lip of the pivot mount 121 (e.g., the inward protruding lips 315, 415 of the first and second pivot mount portions 122, 123) into the recessed ring 206 of the base 110. For example, the connection nodule 203 of the base 110 can be pressed (e.g., press-fitted) or otherwise inserted into a base connection recess of the pivot mount 121 (e.g., base connection recesses 312, 412 of the first and second pivot mount portions 122, 123).

At step 1109, the process 1100 can include attaching a pivot portion 124 to the first pivot mount portion 122. For example, the pivot portion 124 can be connected to a first pivot mount portion 122 by inserting a pivot connection protrusion 509 into a pivot reception recess 120a

At step 1110, the process 1100 can include attaching the pivot portion 124 to the second pivot mount portion 123. For example, the pivot portion 124 can be connected to the second pivot mount portion 123 by inserting a pivot connection protrusion 509 into a pivot reception recess 120b.

At step 1112, the process 1100 can include attaching the first arrow mount portion 126 to the pivot portion 124. For example, the first arrow mount portion 126 can be attached to the pivot portion 124 by inserting a pivot connection protrusion 509 into a pivot reception recess 120c.

At step 1115, the process 1100 can include attaching the second arrow mount portion 127 to the pivot portion 124. For example, the second arrow mount portion 127 can be attached to the pivot portion 124 by inserting a pivot connection protrusion 509 into a pivot reception recess 120d.

At step 1116, the process 1100 can include attaching the second arrow mount portion 127 to a first arrow mount portion 126. For example, the second arrow mount portion 127 can be attached to the first arrow mount portion 126 by inserting a mount support protrusion 606 into an attachment recess 706.

At step 1118, the process 1100 can include attaching a first arrow 130a the second arrow mount portion 127. For example, the first arrow 130a can be attached to the second arrow mount portion 127 by inserting a tail 809 of the first arrow 130a into a first arrow connection point 703a. For example, a tail 809 can be snapped, inserted, screwed, or otherwise connected to the first arrow connection point 703a.

At step 1121, the process 1100 can include attaching a second arrow 130b to the second arrow mount portion 127. For example, the second arrow 130b can be attached to the second arrow mount portion 127 by inserting a tail 809 of the second arrow 130b into a second arrow connection point 703b. For example, a tail 809 can be snapped, inserted, screwed, or otherwise connected to the second arrow connection point 703b.

At step 1124, the process 1100 can include attaching a third arrow 130c to the second arrow mount portion 127. For example, the third arrow 130c can be attached to the second arrow mount portion 127 by inserting a tail 809 of the third arrow 130c into a third arrow connection point 703c. For example, the tail 809 can be snapped, inserted, screwed, or otherwise connected to the third arrow connection point 703c.

While various aspects have been described in the context of a preferred embodiment, additional aspects, features, and methodologies of the claimed systems will be readily discernible from the description herein, by those of ordinary skill in the art. Many embodiments and adaptations of the disclosure and claimed systems other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed systems. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed systems. In addition, some steps may be carried out simultaneously, contemporaneously, or in synchronization with other steps.

Aspects, features, and benefits of the claimed devices and methods for using the same will become apparent from the information disclosed in the exhibits and the other applications as incorporated by reference. Variations and modifications to the disclosed systems and methods may be affected without departing from the spirit and scope of the novel concepts of the disclosure.

It will, nevertheless, be understood that no limitation of the scope of the disclosure is intended by the information disclosed in the exhibits or the applications incorporated by reference; any alterations and further modifications of the described or illustrated embodiments, and any further applications of the principles of the disclosure as illustrated therein are contemplated as would normally occur to one skilled in the art to which the disclosure relates.

The foregoing description of the exemplary embodiments has been presented only for the purposes of illustration and description and is not intended to be exhaustive or to limit the devices and methods for using the same to the precise forms disclosed. Many modifications and variations are possible in light of the above teaching.

The embodiments were chosen and described in order to explain the principles of the devices and methods for using the same and their practical application so as to enable others skilled in the art to utilize the devices and methods for using the same and various embodiments and with various modifications as are suited to the particular use contemplated. Alternative embodiments will become apparent to those skilled in the art to which the present devices and methods for using the same pertain without departing from their spirit and scope.

What is claimed is:

1. A vector measuring device comprising:
a base;
a pivot assembly having a first end and a second end, wherein:
a pivot mount located at the first end of the pivot assembly, the pivot mount comprising (i) a base interface portion that is connected to the base and (ii) a first pivot interface portion;
an arrow mount located at the second end of the pivot assembly, the arrow mount comprising a second pivot interface portion; and
a pivot portion comprising:
a first pivot rod connected to the first pivot interface portion of the pivot mount; and
a second pivot rod connected to the second pivot interface portion of the arrow mount; and
a plurality of directional indicators attached to the arrow mount, the plurality of directional indicators comprising:
a first directional indicator pointing in a first direction;
a second directional indicator pointing in a second direction that is different from the first direction; and
a third directional indicator pointing in a third direction that is different from both the first direction and the second direction.

2. The vector measuring device of claim 1, wherein the base has a generally oblong shape and comprises a first base end and a second base end, wherein the first base end comprises a flared bottom portion and the second base end comprises a recessed ring configured to interface with one or more protrusion of the pivot mount.

3. The vector measuring device of claim 1, wherein the pivot mount is configured to rotate about a vertical axis of the base that intersects the base interface portion of the pivot mount.

4. The vector measuring device of claim 1, wherein the pivot mount comprises:
a first pivot mount portion comprising a first pivot recess configured to receive at least a portion of a first end of the first pivot rod; and
a second pivot mount portion comprising a second pivot recess configured to receive at least a portion of a second end of the first pivot rod,
wherein:
the first pivot mount portion is attached to the second pivot mount portion to form the pivot mount; and
the pivot mount is configured to rotate about a first rod axis that is approximately perpendicular to a vertical axis of the base that intersects the base interface portion of the pivot mount.

5. The vector measuring device of claim 1, wherein the pivot mount is detachably attachable to the base and the pivot portion.

6. The vector measuring device of claim 1, wherein:
the first pivot rod is affixed to the second pivot rod; and
the first pivot rod is approximately perpendicular to the second pivot rod.

7. The vector measuring device of claim 6, wherein one or more interfacing surfaces of the pivot portion, one or more interfacing surfaces of the pivot mount, and/or one or more interfacing surfaces of the arrow mount comprise ridges to thereby cause rotation between (i) the first pivot rod and the pivot mount or (ii) the second pivot rod and the arrow mount to define a plurality of predefined angular positions therebetween.

8. The vector measuring device of claim 1, wherein the arrow mount comprises:
a first arrow mount portion comprising a first pivot recess configured to receive at least a portion of a first end of the second pivot rod; and
a second arrow mount portion comprising a second pivot recess configured to receive at least a portion of a second end of the second pivot rod,
wherein:
the first arrow mount portion is attached to the second arrow mount portion to form the arrow mount;
the arrow mount is configured to rotate about a second rod axis that is approximately perpendicular to a vertical axis of the base that intersects the base interface portion of the pivot mount; and
the first arrow mount portion and/or the second arrow mount portion comprise three arrow connectors, each arrow connector being configured to attach to a corresponding one of the plurality of directional indicators.

9. The vector measuring device of claim 8, wherein one of the arrow connectors or the plurality of directional indicators comprises one or more detent protrusions and another of the arrow connectors or the plurality of directional indicators comprises one or more detent recesses.

10. The vector measuring device of claim 1, wherein the arrow mount is detachably attachable to the pivot portion.

11. The vector measuring device of claim 1, wherein each of the plurality of directional indicators is detachably attachable to the arrow mount.

12. The vector measuring device of claim 1, wherein:
the first direction of the first directional indicator corresponds to a first axis of a Cartesian coordinate system;
the second direction of the second directional indicator corresponds to a second axis of a Cartesian coordinate system; and
the third direction of the third directional indicator corresponds to a third axis of a Cartesian coordinate system.

13. The vector measuring device of claim 1, wherein:
the pivot mount is configured to rotate relative to the base;
the pivot portion is configured to rotate relative to the pivot mount along a first arc path; and
the arrow mount is configured to rotate relative to the pivot portion along a second arc path that is different from the first arc path.

14. The vector measuring device of claim 13, wherein:
the pivot mount is configured to rotate relative to the base about a central vertical axis of the base, wherein the central vertical axis intersects the base interface portion of the pivot mount;
the pivot portion is configured to rotate relative to the pivot mount about a first central rod axis extending through the first pivot rod; and
the arrow mount is configured to rotate relative to the pivot portion about a second central rod axis extending through the second pivot rod.

15. The vector measuring device of claim 14, wherein:
the first central rod axis is approximately perpendicular to the central vertical axis; and
the second central rod axis is approximately perpendicular to the first central rod axis.

16. The vector measuring device of claim 1, wherein each of the base, the pivot assembly, the pivot mount, the pivot portion, the arrow mount, and the plurality of directional indicators comprises a rigid material.

17. A method comprising:
manipulating a pivot mount of a vector measuring device, a pivot portion of the vector measuring device, and an arrow mount of a vector measuring device by rotating the pivot mount with respect to a base of the vector measuring device, rotating the pivot portion with respect to the pivot mount, and rotating the arrow mount with respect to the pivot portion, wherein manipulating the pivot mount, the pivot portion, and the arrow mount cause (i) a first directional indicator of the vector measuring device to align with a first direction of a first vector and (ii) a second directional indicator of the vector measuring device to align with a second direction of a second vector; and
determining a resultant direction of a third directional indicator of the vector measuring device, wherein the resultant direction corresponds to a third direction of a third vector resulting from a product of the first vector and the second vector.

18. A method comprising:
attaching a pivot mount to a base;
attaching a first pivot rod of a pivot portion to the pivot mount, wherein the pivot portion comprises the first pivot rod and a second pivot rod that is (i) fixedly attached to the first pivot rod and (ii) approximately perpendicular to the first pivot rod;
attaching the second pivot rod to an arrow mount;
attaching a first directional indicator to a first arrow connector of the arrow mount to thereby cause the first directional indicator to point in a first direction;
attaching a second directional indicator to a second arrow connector of the arrow mount to thereby cause the first directional indicator to point in a second direction that is approximately perpendicular to the first direction; and
attaching a third directional indicator to a third arrow connector of the arrow mount to thereby cause the third directional indicator to point in a third direction is that approximately perpendicular to the first direction and approximately perpendicular to the second direction.

19. The method of claim 18, wherein attaching the pivot mount to the base comprises:
attaching a first pivot mount portion to the base;
attaching a second pivot mount portion to the base; and
attaching the second pivot mount portion to the first pivot mount portion to thereby form the pivot mount.

20. The method of claim 19, wherein attaching the second pivot rod to the arrow mount comprises:
attaching a first end of the second pivot rod to a third pivot recess of a first arrow mount portion;
attaching a second end of the second pivot rod to a fourth pivot recess of a second arrow mount portion; and
attaching the first arrow mount portion to the second arrow mount portion to thereby form the arrow mount.
